(19) United States
(12) Patent Application Publication
(10) Pub. No.: US 2013/0259227 A1
(43) Pub. Date: Oct. 3, 2013

(54) INFORMATION PROCESSING DEVICE AND COMPUTER PROGRAM PRODUCT

(71) Applicants: Yoshikazu HANATANI, Kanagawa (JP); Toru KAMBAYASHI, Kanagawa (JP); Masahiro ISHIYAMA, Kanagawa (JP)

(72) Inventors: Yoshikazu HANATANI, Kanagawa (JP); Toru KAMBAYASHI, Kanagawa (JP); Masahiro ISHIYAMA, Kanagawa (JP)

(21) Appl. No.: 13/724,735

(22) Filed: Dec. 21, 2012

(30) Foreign Application Priority Data
Mar. 27, 2012 (JP) 2012-071657

(51) Int. Cl. H04L 9/08

(52) U.S. Cl. CPC H04L 9/0816
USPC 380/44

(57) ABSTRACT

According to an embodiment, an information-processing device is coupled to an external device and a server. The information-processing device includes a device key storage configured to store a device key; and an MKB processor configured to generate a media key from the device key and a media key block. The information-processing device also includes a shared key generator configured to generate a shared key from the media key and secret information transmitted from the server. The shared key is shared by the information-processing device and the external device.

### CROSS-REFERENCE TO RELATED APPLICATION

This application is based upon and claims the benefit of priority from Japanese Patent Application No. 2012-071657, filed on Mar. 27, 2012; the entire contents of which are incorporated herein by reference.

### FIELD

Embodiments described herein relate generally to an information processing device and a computer program product.

### BACKGROUND

Pre-shared key authentication exchange during execution of a protocol is an efficient process. However, a problem arises in that a shared key in each device increases management cost. A known technique introduces a secure server so as to avoid this problem. In this technique, each device and the server first authenticate each other so as to safely share the pre-shared key. Subsequently, the server distributes data used for authentication of a device and key issuance. The data is used in the case where the authenticated key exchange is executed between two devices. The known technique includes Kerberos authentication and similar authentication.

However, the authenticated key exchange system, which uses a pre-shared key through the server, such as the conventional Kerberos authentication depends on a reliable server for all of shared key generation, authentication, and determination of communication availability for communication between devices. Additionally, this server may acquire a shared key used for communication between devices. Thus, a problem arises in that the server may intercept the communication between devices. In other words, this authentication has a system configuration largely depending on reliability of the server.

### BRIEF DESCRIPTION OF THE DRAWINGS

FIG. 1 is a block diagram of a system according to a first embodiment;

FIG. 2 is a block diagram of a KDC;

FIG. 3 is a block diagram of a device;

FIG. 4 is a block diagram of a server;

FIG. 5 is a sequence diagram of a process to distribute a media key block (MKB);

FIG. 6 is a sequence diagram of a process to share a key;

FIG. 7 is a sequence diagram of a process to share a key according to Modification 4;

FIG. 8 is a sequence diagram of a process to share a key according to a second embodiment;

FIG. 9 is a sequence diagram of a process to share a key according to a third embodiment;

FIG. 10 is a sequence diagram of a process to share a key according to Modification 13;

FIG. 11 is a sequence diagram of a process to share a key according to Modification 14; and

FIG. 12 is a diagram of a hardware configuration according to the first through the third embodiment.

### DETAILED DESCRIPTION

According to an embodiment, an information-processing device is coupled to an external device and a server. The information-processing device includes a device key storage configured to store a device key; and an MKB processor configured to generate a media key from the device key and a media key block. The information-processing device also includes a shared key generator configured to generate a shared key from the media key and secret information transmitted from the server. The shared key is shared by the information-processing device and the external device.

An information-processing device according to a preferred embodiment of the present invention will be described in detail below by referring to the accompanying drawings.

### First Embodiment

As described above, the conventional method employs a system configuration that depends largely on the reliability of a server. In this case, the server needs to be built and operated securely. This system increases cost. Additionally, the server cannot be installed in a location vulnerable to strong attack such as physical analysis, for example, in an outdoor location. This has been a problem on the system configuration.

In view of this, while a system including an information-processing device according to a first embodiment employs a method for sharing a key between devices using the server, the function to determine whether communications are available or not is separated from the server. This reduces dependency on the servers. This ensures a lower cost to build and operate the server. This system updates a media key block (MKB) so as to distribute a common media key only to devices in which an information leakage has not occurred. Thus, this system prevents information leakage while the server does not determine whether communications are available or not.

The system including an information-processing device (a device) according to this embodiment employs an MKB. The MKB can acquire (generate) a media key appropriate to calculate a shared key that is used in a predetermined method for sharing a key. A key distribution device (hereinafter referred to as a key distribution center (KDC)) distributes the MKB to respective devices. Each device generates a media key from the MKB and the device key of the own device. Then, to generate a shared key for communications with another device (an external device), each device uses the generated media key and data acquired by accurately processing data distributed from the server.

Accordingly, the server does not need to judge whether communications are available or not for communication between devices, differently from conventional systems. The KDC generates MKBs, which are common in each group of the devices that are allowed to communicate with, and distributes the MKBs using any method so as to control the permission of communications between the devices. The server simply needs to issue data that is used to generate a shared key between the devices in response to a request from a device. In the case where a device is not allowed to communicate, the KDC simply needs to redistribute a common MKB, which is updated such that the device is unable to process accurately. That is, the KDC simply needs to distribute the MKB such that the system is able to update the group where each device belongs to, and easily control the permission of communications between the devices. In the case where the KDC distributes the MKB that a device is unable to process, the device or the device key installed in the device is called the disabled one.

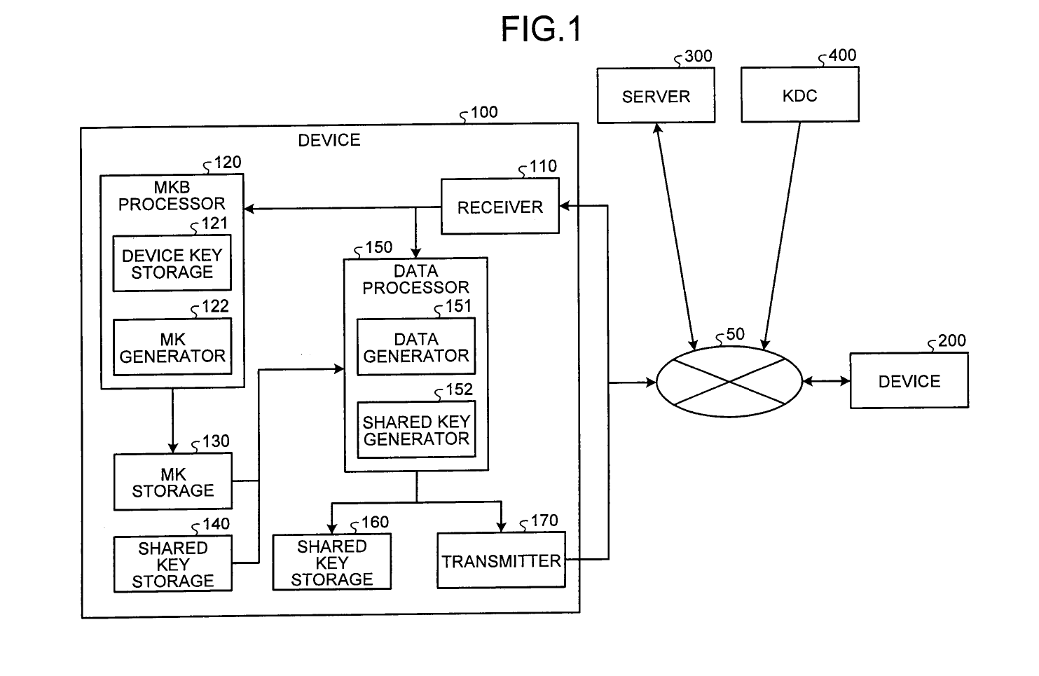

FIG. 1 is a block diagram illustrating an exemplary system configuration according to a first embodiment. As illustrated in FIG. 1, the system according to this embodiment includes a plurality of devices 100 and 200 as information-processing devices, a server 300 as a server, and a KDC 400, which are all coupled via a network 50. Any form of networks such as the Internet is applicable to the network 50.

The number of the devices 100 and 200 is not limited to two. The system may be configured with three or more devices. The server 300 is not limited to one server. The system may be configured with the devices equal to or more than two servers 300. The number of KDCs 400 is also not limited to just one. Multiple KDCs 400 may be employed.

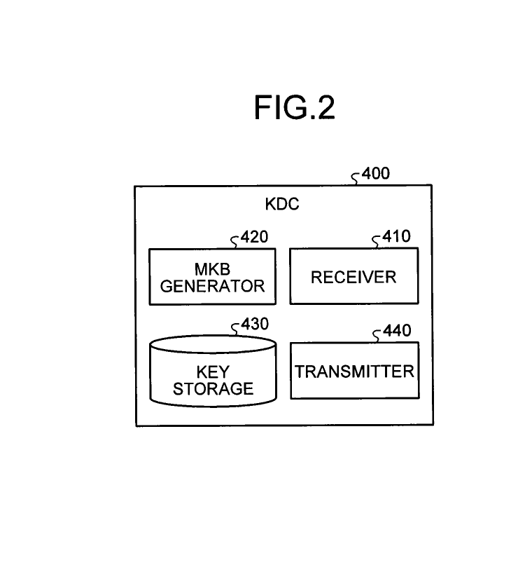

The KDC 400 generates the media key and the MKB, distributes the MKB, and executes a similar process. FIG. 2 is a block diagram illustrating an exemplary configuration of the KDC 400. As illustrated in FIG. 2, the KDC 400 includes a receiver 410, a transmitter 440, an MKB generator 420, and a key storage 430.

The receiver 410 receives various data from devices such as the devices 100 and 200, and the server 300. The transmitter 440 transmits various data to devices such as the devices 100 and 200, and the server 300. For example, the transmitter 440 transmits an MKB, which is generated by the MKB generator 420, to the devices 100 and 200. A method to input an MKB to the devices 100 and 200 is not limited to this method. For example, it may be configured such that the MKB may be input to the devices 100 and 200 via a storage medium that stores the MKB. It may also be configured such that the MKB may be added to data that the server 300 transmits, so as to input it.

The key storage 430 stores device keys assigned to the devices 100 and 200. The key storage 430 stores all device keys in the MKB method.

The MKB generator 420 generates MKBs using the device keys. Any methods such as the complete sub-tree method, the subset difference method, and the logical key hierarchy method may be employed as the method for generating the MKB.

The KDC 400 has a public key KP for signature verification, as public information. The KDC 400 maintains a secret key KS corresponding to the public key KP. The secret key KS is secret information that the KDC 400 only knows. The public key KP and the secret key KS may employ, for example, a public key and a secret key of a digital signature using elliptic curves.

Returning to FIG. 1, at least one device key is assigned to the devices 100 and 200. The KDC 400 gives a bit string x, which has a length equal to or more than a predetermined length, as a media key of the MKB. The bit string x is selected by the KDC 400. In the description below, the bit string x will be referred to as a media key x.

After receiving the MKB, the devices 100 and 200 process the MKB with the device key assigned to the device 100. Then, the devices 100 and 200 acquire the media key x and store the media key x in an MK storage 130. In this respect, in the case where the device 100 is disabled by the MKB, the device 100 is unable to accurately acquire the media key x because the device 100 is unable to accurately decrypt the MKB.

The devices 100 and 200 hold a pre-shared key that is shared with the server 300. For example, the device 100 and the server 300 each hold a pre-shared key psk1. The devices 100 and 200, and the server 300 are able to share the pre-shared key psk1 by preliminarily using, for example, the authenticated key exchange based on a public key encryption system such as PKINIT.

The device 100 includes a receiver 110, an MKB processor 120, the MK storage 130, a shared key storage 140, a data processor 150, a shared key storage 160, and a transmitter 170.

The receiver 110 receives various data from the devices such as the device 200, the server 300 and the KDC 400. The device 200 corresponds to the external device for the device 100. For example, the receiver 110 receives encrypted data sent by the server 300, the MKB transmitted by the KDC 400, or the like. The receiver 110 transmits the received data to the MKB processor 120 or the data processor 150.

The MKB processor 120 stores the device key of the device 100. For example, the MKB processor 120 receives the MKB from the receiver 110. In the case where the device key of the device 100 is not disabled, the MKB processor 120 generates the media key x from the MKB. The MKB processor 120 transmits the generated media key x to the MK storage 130.

The MK storage 130 receives the media key x from the MKB processor 120, and stores the media key x. The MK storage 130 transmits the stored media key x to the data processor 150, in response to a request from the data processor 150.

The shared key storage 140 stores the shared key (hereinafter referred to as the pre-shared key K10) that is preliminarily shared by the device 100 and the server 300. Preliminarily, the method for sharing the pre-shared key K10 has no specific limitations, and any predetermined methods may be used. For example, a method using public key encryption, or a method that directly shares via media or a similar method without using the network 50 may be used.

The data processor 150 executes various data processes so as to generate a shared key (shared key 2) shared with the device 200. For example, the data processor 150 receives data transmitted from the server 300 through the receiver 110, receives the media key x from the MK storage 130, and receives the pre-shared key K10 from the shared key storage 140. The data processor 150 generates data using the received data, and transmits the generated data to the server 300 or the device 200. The data processor 150 generates the shared key 2, which is used to communicate with the device 200.

The shared key storage 160 receives the shared key 2 from the data processor 150 and stores the shared key 2.

The transmitter 170 transmits various data to devices such as the device 200 and the server 300. For example, the transmitter 170 transmits data received from the data processor 150 to the server 300 or the device 200.

In order to prevent forgery of the MKB, the system may be configured such that the MKB processor 120 confirms the signature of the MKB. In this case, for example, the KDC 400 generates a digital signature corresponding to an MKB using the secret key KS so as to indicate validity of the MKB, and transmits the digital signature with the MKB. The MKB processor 120 stores the public key KP of the KDC 400, and then confirms the signature of the MKB using the public key KP.

In order to reduce the data size of the MKB that is transmitted to devices, the KDC 400 may be configured to control the devices categorized by some groups. In this case, each device transmits the group identification information, to which the device belongs, to the KDC 400. Examples of the group identification information are a number corresponding to a leaf of the device key categorized in a tree structure, a unique ID corresponding to each device, a group ID previously assigned to each device, or the like. The KDC 400 transmits a part of the MKB corresponding to the group and the signature corresponding to the part. In this case, the signature for an MKB is created by each MKB corresponding to each group.

The MKB processor 120 may be configured to transmit the version number of an MKB to the transmitter 170, for example, via the MK storage 130 or the data processor 150. The version number of the MKBs is in the form of data in a sequential numbers corresponding to the MKB. The device 100 may be configured to exchange the version number before the processing of sharing a key with the device 200. In the case where the device 100 or the device 200 has an old version number, a key is not exchanged. The device 100 and the device 200 may be configured to exchange data after sharing a key to confirm that a shared key is shared correctly between the device 100 and the device 200.

Next, an exemplary configuration of the MKB processor 120 will be described in detail. As illustrated in FIG. 1, the MKB processor 120 has a device key storage 121 and an MK generator 122.

The device key storage 121 stores a device key assigned to the device 100. The MK generator 122 reads an MKB, processes the MKB using the device key stored in the device key storage 121, and generates a media key x. The MK generator 122 transmits the generated media key x to the MK storage 130. In this respect, an MKB storage (not shown) may be provided instead of the MK storage 130, so as to process the MKB in each case as necessary and transmit the media key x, which is generated by the MK generator 122, directly to the data processor 150.

Next, an exemplary detailed configuration of the data processor 150 will be described. As illustrated in FIG. 1, the data processor 150 includes a data generator 151 and a shared key generator 152.

The data generator 151 generates data to transmit to the transmitter 170 and data to transmit to the shared key generator 152, from the pre-shared key K10 received from the shared key storage 140 and data received from the receiver 110.

For example, the data generator 151 receives encrypted data T1 and encrypted data T2 from the receiver 110. For example, the encrypted data T1 is encrypted data, which is generated by encrypting secret information K with the pre-shared key K10 that is shared by the server 300 and the device 100. The secret information K is a piece of information used to generate a shared key between the device 100 and the device 200. The secret information K is generated by the server 300. The encrypted data T2 is encrypted data, which is generated by encrypting secret information K with the pre-shared key that is shared by the server 300 and the device 200. In this case, the data generator 151 decrypts the encrypted data T1 using the pre-shared key K10 so as to obtain the secret information K, and transmits the secret information K to the shared key generator 152. The data generator 151 transmits the encrypted data T2 to the device 200 via the transmitter 170.

The shared key generator 152 calculates the shared key 2 from the media key x received from the MK storage 130 and data received from the data processor 150. In the case where the shared key generator 152 receives the secret information K from the data processor 150, the shared key generator 152 applies a predetermined process to the secret information K and the media key x, so as to calculate the shared key 2.

A predetermined and cryptographically secure function such as a cryptographic hash function H or a pseudorandom function may be used to calculate the shared key 2.

In the example described above, two variables, the media key x and the secret information K are input to calculate the shared key 2. The system may be configured such that two variables or more variables are input to calculate the shared key 2.

Each storage (the device key storage 121, the MK storage 130, the shared key storage 140, the shared key storage 160) described above may be configured with generally used storage media such as a hard disk drive (HDD), an optical disk, a memory card, a random access memory (RAM).

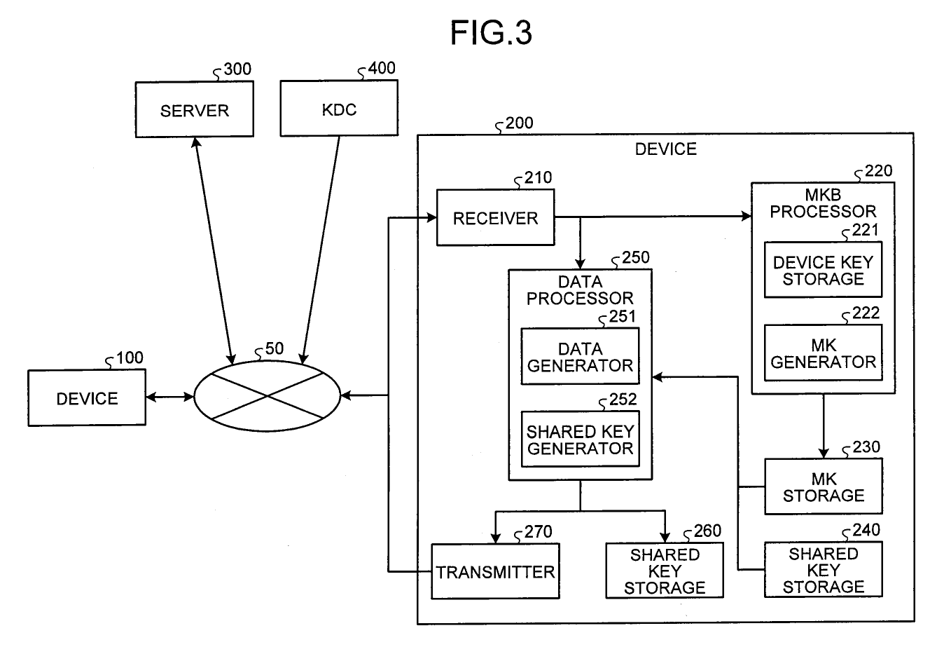

Next, an exemplary configuration of the device 200 will be described. FIG. 3 is a block diagram illustrating an exemplary configuration of the device 200. As illustrated in FIG. 3, the device 200 includes a receiver 210, an MKB processor 220, an MK storage 230, a shared key storage 240, a data processor 250, a shared key storage 260, and a transmitter 270.

The function of a data generator 251 in the data processor 250 in the device 200 differs from the function of the data generator 151 in the device 100. The descriptions concerning functions of other units namely: the receiver 210, the MKB processor 220, the MK storage 230, the shared key storage 240, the shared key storage 260, and the transmitter 270 are omitted from the following embodiment for brevity as the functions of the respective units are largely similar to: the receiver 110, the MKB processor 120, the MK storage 130, the shared key storage 140, the shared key storage 160, and the transmitter 170 in the device 100.

As described in the example above, the device 200 transmits the encrypted data T2, which is received from the device 100, to the data generator 251. The data generator 251 provides functions of, for example, using the pre-shared key shared with the server 300 to decrypt the encrypted data T2 to acquire the secret information K, and transmitting the secret information K to a shared key generator 252. The data generator 251 also provides another function of, for example, calculating the data indicating that the secret information K is calculated and transmitting the data to the transmitter 270.

For the data indicating that the secret information K is calculated, any data may be used such as simple truth value, a message authentication code using the secret information K corresponding to a document predetermined by the device 100, and encrypted data using the secret information K.

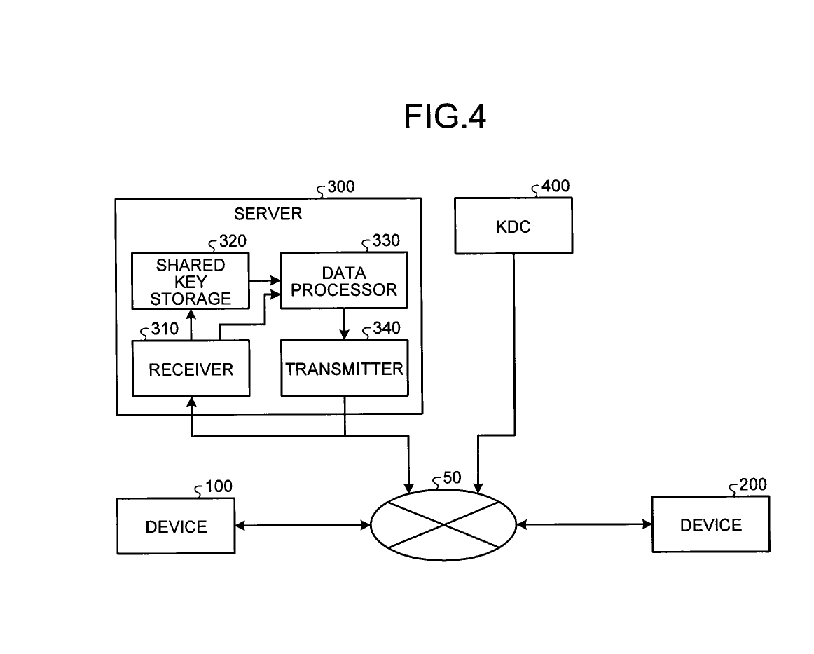

Next, an exemplary configuration of the server 300 will be described. FIG. 4 is a block diagram illustrating an exemplary configuration of the server 300. As illustrated in FIG. 4, the server 300 has a receiver 310, a shared key storage 320, a data processor 330, and a transmitter 340.

The receiver 310 receives various data from devices such as the devices 100 and 200.

The shared key storage 320 stores pre-shared keys which are preliminarily shared with the devices 100 and 200 by some means.

The data processor 330 receives data from the receiver 310. The data processor 330 reads out an appropriate pre-shared key corresponding to the data from the shared key storage 320. The pre-shared key is used to calculate output data and transmit the output data to the transmitter 340. For example, the data processor 330 outputs encrypted data of the secret information K using the pre-shared key, which has been read out.

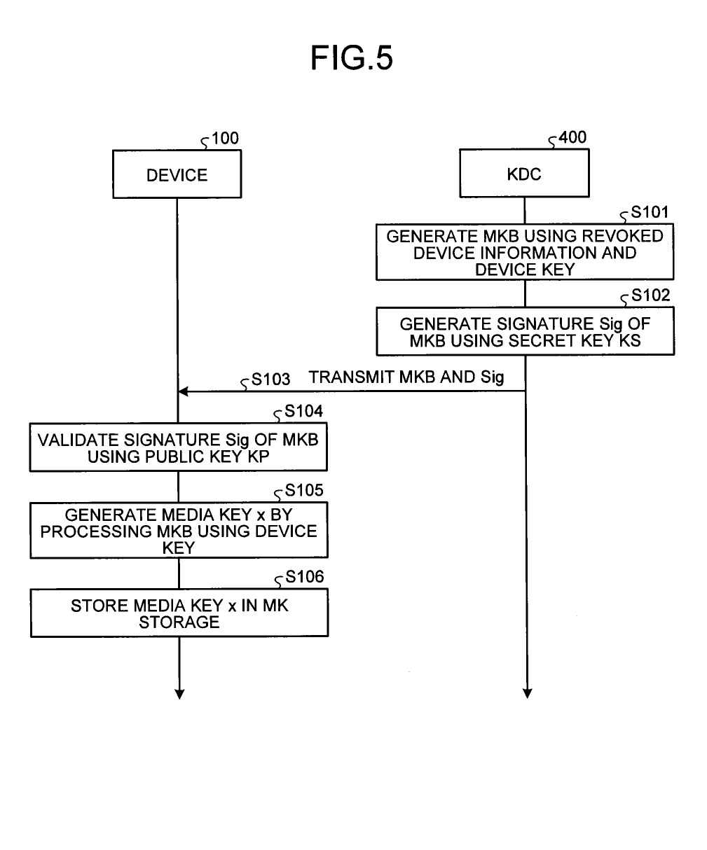

Next, a process to distribute an MKB by a KDC 400 and devices 100 and 200 according to this embodiment will be described by referring to FIG. 5. FIG. 5 is a sequence diagram illustrating an entire sequence of a process to distribute an MKB according to this embodiment.

First, the MKB generator 420 in the KDC 400 generates an MKB using a portion of information (the revoked device information) and a device key (step S101). The revoked device information specifies which devices have permission to communicate. Then, the KDC 400 generates the signature Sig of MKB for the generated MKB using the secret key KS (step S102). The transmitter 440 in the KDC 400 distributes the MKB and the generated signature Sig to the device 100 (step S103).

The MKB processor 120 in the device 100 validates the signature Sig of the MKB using a public key KP (step S104). In the case where the signature Sig is not validated, subsequent processing will be cancelled.

The MKB processor 120 processes the MKB using the device key, which is stored in the device key storage 121, so as to generate the media key x (step S105). In the case where the MKB processor 120 is unable to process the MKB, the device 100 is not permitted to communicate, and subsequent processing will be cancelled.

The MK storage 130 in the device 100 stores the media key x (step S106).

Other devices such as the device 200 also validate the signature of the MKB, generate the media key x, and store the generated media key x in a similar way.

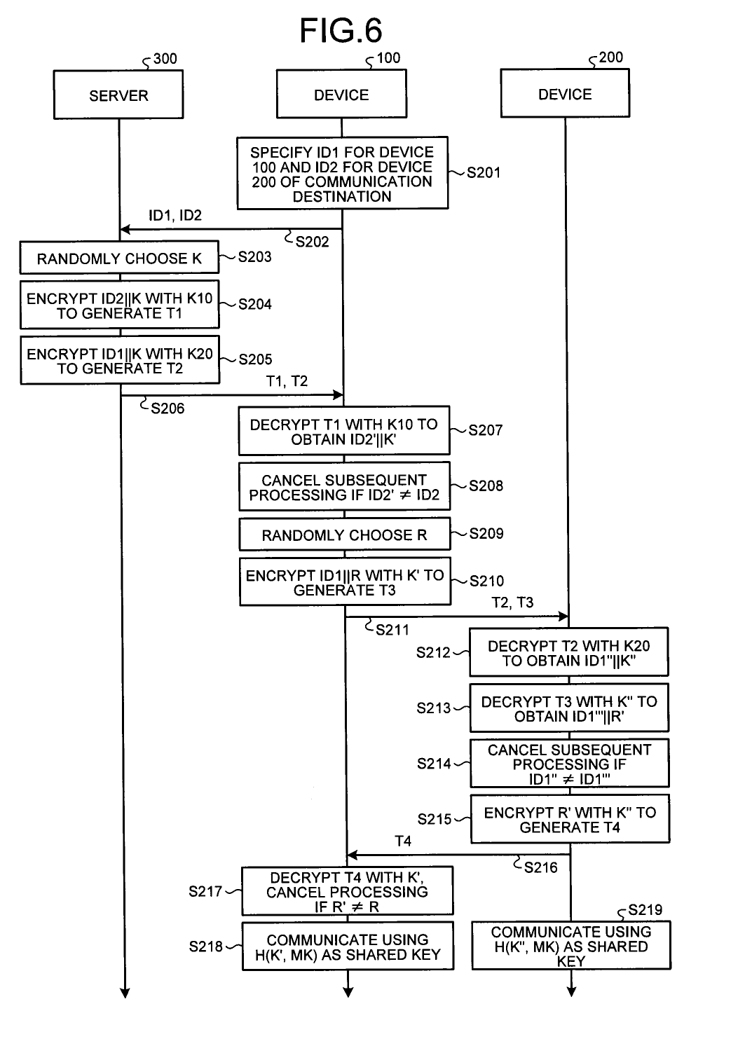

Next, a process to share a key by the device 100, the device 200, and the server 300 will be described by referring to FIG. 6.

Assume that the server 300 and the device 100 share a pre-shared key K10, while the server 300 and the device 200 share a pre-shared key K20, using an existing method such as PKINIT. Assume that the device 100 and the device 200 share a common media key MK using the MKB and the respective device keys.

FIG. 6 is a sequence diagram illustrating an entire sequence of a process to share a key according to this embodiment. In the example below, an exemplary key-sharing process to establish communications between the device 100 and the device 200 will be described.

First, the device 100 specifies an identifier ID1 for the device 100 and an identifier ID2 for the device 200, and transmits the identifiers to the server 300 (step S201, step S202).

The data processor 330 in the server 300 reads the respective pre-shared keys corresponding to ID1 and ID2 out of the shared key storage 320. In the case where at least one of corresponding pre-shared keys is not recorded, subsequent processing will be cancelled.

The data processor 330 in the server 300 randomly chooses secret information K (step S203). The data processor 330 encrypts ID2∥K with K10 to generate the encrypted data T1 (step S204). The data processor 330 also encrypts ID1∥K with K20 to generate the encrypted data T2 (step S205). Here, the symbol “∥” stands for data connection. Any methods other than connection may be employed insofar as each data is able to be specified.

The data processor 330 transmits the encrypted data T1 and the encrypted data T2 to the device 100 via the transmitter 340 (step S206).

The data processor 150 in the device 100 decrypts the encrypted data T1 with the pre-shared key K10, which is stored in the shared key storage 140, so as to obtain ID2′ and K′ (step S207). In the case where ID2′ is not equal to ID2, the data processor 150 will cancel subsequent processing (step S208).

Next, the data processor 150 randomly chooses an R (step S209). The data processor 150 encrypts ID1∥R with K′ to generate encrypted data T3 (step S210). The data processor 150 sends the encrypted data T2 and the encrypted data T3 to the device 200 via the transmitter 170 (step S211).

The data processor 250 in the device 200 utilizes the pre-shared key K20, which is stored in the shared key storage 260, to decrypt the encrypted data T2, thus acquiring ID1″ and K″ (step S212). The data processor 250 decrypts the encrypted data T3 with K″ to acquire ID1′″ and R′ (step S213). In the case where ID1″ is not equal to ID1′″, the data processor 250 will cancel subsequent processing (step S214).

Next, the data processor 250 encrypts R′ with K″ and calculate encrypted data T4 (step S215). The data processor 250 transmits the T4 to the device 100 via the transmitter 270 (step S216).

Next, the shared key generator 252 calculates H(K″, MK) using a hash function H and then stores H(K″, MK) in the shared key storage 260 (step S219). H(K″, MK) is used as the shared key, which is shared with the device 100 (which corresponds to the shared key 2 described above).

The data processor 150 in the device 100 decrypts the encrypted data T4 with K′ to acquire R′. In the case where R′ is not equal to R, the subsequent processing will be cancelled (step S217). Next, the shared key generator 152 calculates H(K′, MK) using the hash function H and then stores H(K′, MK) in the shared key storage 160 (step S218). H(K′, MK) is used as the shared key, which is shared with the device 200 (which corresponds to the shared key 2 described above).

With the respective appropriate pre-shared keys K10 and K20, the encrypted data T1 and encrypted data T2, which are issued according to the procedure by the server 300, are decrypted. This allows the device 100 and the device 200 to share the secret information K. Accordingly, since K″ is equal to K′, the devices 100 and 200 are able to accurately share the shared key generated from that K″ is equal to K′. In contrast, the device that does not have an appropriate pre-shared key (the pre-shared keys K10 and K20) is unable to acquire the information related to the secret information K at all, due to security provided by the symmetric-key cryptography.

The server 300 is unable to calculate the shared key H(K, MK), which is used for communication between the device 100 and the device 200, because the server 300 does not have the media key MK. Accordingly, the security of communication between the device 100 and the device 200 is guaranteed even if the server 300 attempts to sniff the communication.

The system is protected from attacks such as spoofing and sniffing even if the KDC 400, the server 300, the device 100, and the device 200 would individually behaves illegally.

Modification 1

In Modification 1, a server 300 also has a device key to process an MKB. In the embodiment described above, the server 300 employs only the pre-shared key, which is shared with devices, for encryption. In this modification, the server 300 employs a media key MK, which is acquired by processing an MKB, and a pre-shared key for encryption (such as step S204 and step S205 in FIG. 6). With this system configuration, a KDC 400 is able to update the MKB so as to control communication availability of the server 300.

Modification 2

In the system described above, one MKB is employed. In contrast, a plurality of the MKB may be employed. In Modification 2, for example, the server 300 includes an MKB 1 and a device key to process the MKB 1. The device 100 and the device 200 also include an MKB 1 and a device key to process the MKB 1. The device 100 and device 200 include an MKB 2 and a device key to process the MKB 2.

The server 300 in this modification generates encrypted data with a media key MK1, which is acquired by processing the MKB 1, and a pre-shared key shared with respective devices. In this modification, the devices 100 and 200 process a media key MK2, which is acquired by processing the MKB 2, and encrypted data, which is received from the server 300, to acquire secret information K. Then, the devices 100 and 200 calculate a shared key shared by devices, from the secret information K and the media key MK2.

With this system configuration, the system achieves the function to control communication availability of the server 300 while preventing sniffing by the server 300.

Modification 3

In the system described above, each device employs the common MKB. In contrast, Modification 3 employs different MKBs. For example, devices may be categorized into some groups as described above, and assigned with different MKBs for each group.

For example, assume that the device 100 includes an MKB 1 and a device key that processes the MKB 1, while the device 200 includes an MKB 2 and a device key that processes the MKB 2. The device 100 acquires a media key MK1 by processing the MKB 1, while the device 200 obtains a media key MK2 by processing MKB 2. The subsequent processing is similar to the embodiment described above.

In this case, the device 100 and the device 200 are unable to accurately calculate the shared key insofar as the device 100 and the device 200 follow the procedure. In other words, this modification is able to prevent communication between devices that belong to different groups. A plurality of groups is securely managed with the single server 300 by distributing the media key MK that is unique to each device.

Modification 4

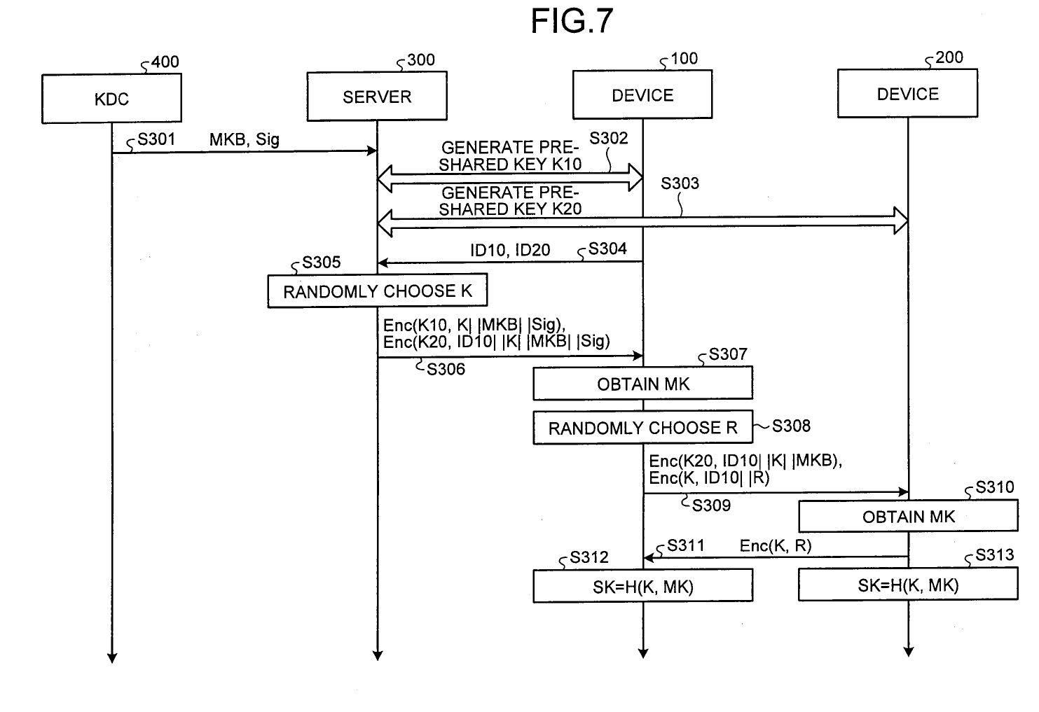

In the embodiment described above, each device receives the MKB directly from the KDC 400. In Modification 4, each device concurrently receives an MKB when each device receives encrypted data from the server 300. FIG. 7 is a sequence diagram illustrating an entire sequence of a process to share a key according to Modification 4.

A KDC 400 transmits an MKB and a signature Sig of MKB to a server 300 (step S301). The server 300 generates respective pre-shared keys K10 and K20 between the device 100 and the device 200 (step S302, step S303).

Similarly to step S202 in FIG. 6, the device 100 transmits an identifier ID10 of the device 100 and an identifier ID20 of the device 200 to the server 300 (step S304).

Similarly to step S203 in FIG. 6, a data processor 330 in the server 300 randomly chooses secret information K (step S305).

In this modification, the data processor 330 encrypts data including the MKB to generate encrypted data. For example, the data processor 330 encrypts ID20∥K∥MKB∥Sig with K10 to generate encrypted data, and encrypts ID10∥K∥MKB∥Sig with K20 to generate encrypted data. Then the data processor 330 transmits the encrypted data to the device 100 via the transmitter 340 (step S306).

In the device 100, for example, the data generator 151 decrypts the encrypted data, which is received from the server 300, to acquire the MKB. The MK generator 122 in the device 100 processes the acquired MKB to generate a media key MK (step S307). Next, the data processor 150 randomly chooses an R (step S308).

In this modification, the data processor 150 encrypts data including the MKB to generate encrypted data. For example, the data processor 150 encrypts ID10∥R with K to generate encrypted data. Then the data processor 150 transmits the encrypted data ID10∥K∥MKB∥Sig received from the server 300 and ID10∥R with K to the device 200 via the transmitter 170 (step S309).

In the device 200, for example, the data generator 251 decrypts the encrypted data, which is received from the device 100, to acquire the MKB. An MK generator 222 in the device 200 processes the acquired MKB to generate a media key MK (step S310). The data processor 250 decrypts encrypted data, which is received from the device 100, to acquire ID10 and R. Then the data processor 250 encrypts R with K to generate encrypted data. Then the data processor 250 transmits the encrypted data to the device 100 via the transmitter 270 (step S311).

The devices 100 and 200 calculate the respective shared key SK=H(K, MK) (step S312, step S313) and use the shared key SK=H(K, MK) for communication.

The encrypted data, which is transmitted from the server 300, includes the signature Sig of MKB. The signature Sig is attached in the KDC 400. Accordingly, the device 100 is able to validate the MKB, which is transmitted from the server 300, with the signature Sig. For example, even if the MKB is falsified in the server 300, the device 100 is able to avoid the process executed by an unauthorized MKB.

As described above, the KDC 400 may be configured to generate the MKB and the signature for each divided group, and transmit a combination of the MKB and the signature to the server 300. In this case, the server 300 may be configured to choose and transmit a combination of the MKB and the signature corresponding to two IDs received from a device.

Modification 5

In the embodiment described above, the server 300 and the KDC 400 are configured as different devices. In contrast, the system may be configured such that one device provides the function of the server 300 and the function of the KDC 400 described above. This type of configuration may provide a secure system by including both the functions of the server 300 and the KDC 400 in so far as the function corresponding to the KDC is securely achieved by employing a technique to protect from physical analysis, such as tamper resistance technique. In this example, tamper resistance techniques are applied to a lower number of functions compared with conventional systems. This reduces achievement costs or operational costs and increases processing efficiency of the server 300.

### Second Embodiment

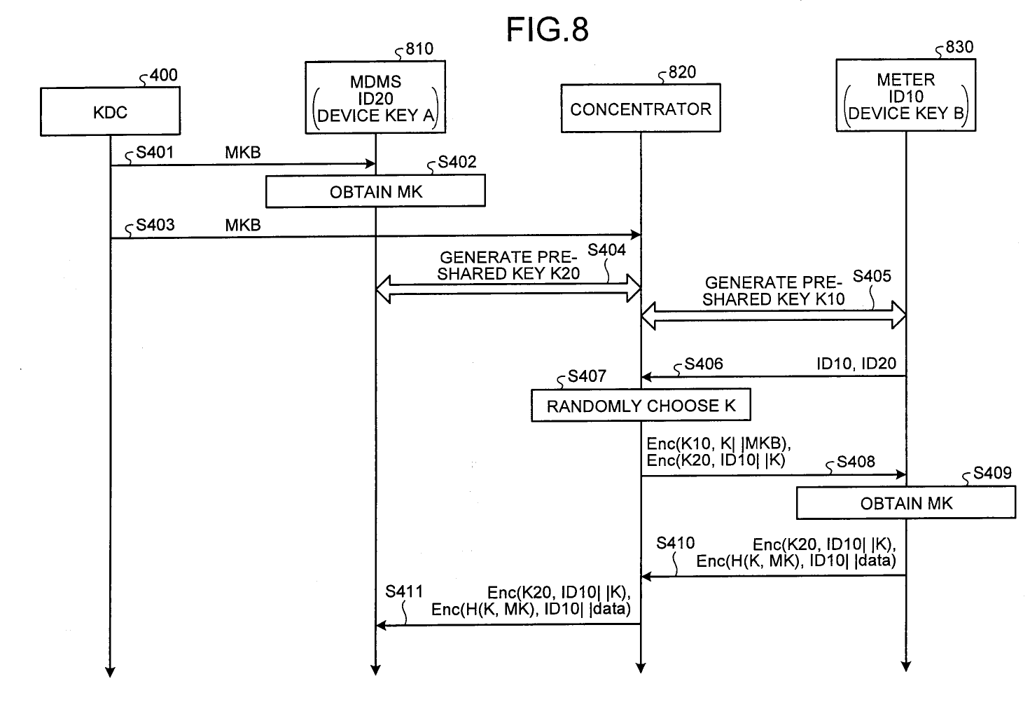

A typical embodiment where an information-processing device is applied to a smart grid will be described as the second embodiment. FIG. 8 is a sequence diagram illustrating an entire sequence of a process to share a key according to a second embodiment. In this embodiment, a concentrator 820 corresponds to the server 300 of the first embodiment. A meter 830 and a meter data management system (MDMS) 810 correspond to the devices of the first embodiment. The MDMS 810 and the meter 830 are assigned with the device keys different from each other (a device key A and a device key B). FIG. 8 illustrates an exemplary system that transmits information collected by the meter 830 to the MDMS 810 through the concentrator 820.

The KDC 400 transmits the MKB to the MDMS 810 (step S401). The MDMS 810 processes the MKB to generate the media key MK (step S402). The KDC 400 transmits the MKB to the concentrator 820 (step S403).

The concentrator 820 respectively generates pre-shared keys K20 and K10 between the MDMS 810 and the meter 830 (step S404, step S405).

The meter 830 transmits an identifier ID10 of the meter 830 and an identifier ID20 of the MDMS 810 to the concentrator 820 (step S406).

The concentrator 820 randomly chooses secret information K (step S407). The concentrator 820 generates encrypted data El, which is generated by encrypting data (such as K∥MKB or ID20∥K∥MKB) including the K and the MKB with K10, and encrypted data E2, which is generated by encrypting data (such as ID10∥K or K) including the K with K20, and then transmits to the meter 830 (step S408).

The meter 830 decrypts the E1 among the encrypted data received to acquire the K and the MKB. The meter 830 processes the acquired MKB to generate the media key MK (step S409). The meter 830 employs the K and the MK to generate the shared key H(K, MK).

The meter 830 encrypts ID10∥data with the shared key H(K, MK) to generate encrypted data E3. Then the meter 830 transmits the encrypted data E2, which is generated by encrypting ID10∥K received from the concentrator 820 with the K20, and the E3 to the concentrator 820 (step S410). Here, “data” denotes arbitrary information. For example, the meter 830 is able to include collected information in the “data”.

The concentrator 820 forwards the received encrypted data to the MDMS 810 (step S411).

Modification 6

In Modification 5, the E1 is generated from data including the MKB. In contrast, the MKB may be transmitted without encryption. Alternatively, only a required subset of the MKB may be attached depending on the device.

Modification 7

In Modification 5, the encrypted K∥MKB as the E1 and the encrypted ID10∥K as the E2 are used. In contrast, the encrypted RN∥K∥MKB as the E1 and the encrypted RN∥K as the E2 may be used. Here, the RN is assumed to be a random number generated by the concentrator 820 for each communication. With the configuration described above, the meter 830 is able to securely transmit data while concealing its ID from the MDMS 810. The MDMS 810 is able to securely receive data from the meter that is permitted by the MKB for communication while the ID is concealed from the MDMS 810.

Modification 8

In the second embodiment, the KDC 400 and the MDMS 810 are configured as different devices. In contrast, the system may be configured such that one device provides the function of the KDC 400 and the function of the MDMS 810. In this case, the MDMS 810 also controls the permission of communication. With this configuration, simply achieving the secure function of the KDC 400 ensures that the permission of communication is securely controlled.

Modification 9

In the second embodiment, the KDC 400 and the concentrator 820 are configured as different devices. In contrast, the system may be configured such that one device provides the function of the KDC 400 and the function of the concentrator 820. In this case, the concentrator 820 also controls the permission of communication. This configuration ensures that the permission of communication is securely controlled and limits damage to the system insofar as at least the KDC 400 stays secure, even in the event that security provided by the functions of units other than the KDC 400 in the concentrator is all broken. Accordingly this reduces the overall number of functions to secure. Consequently, this reduces achievement costs or operational costs and increases processing efficiency of the KDC 400.

### Third Embodiment

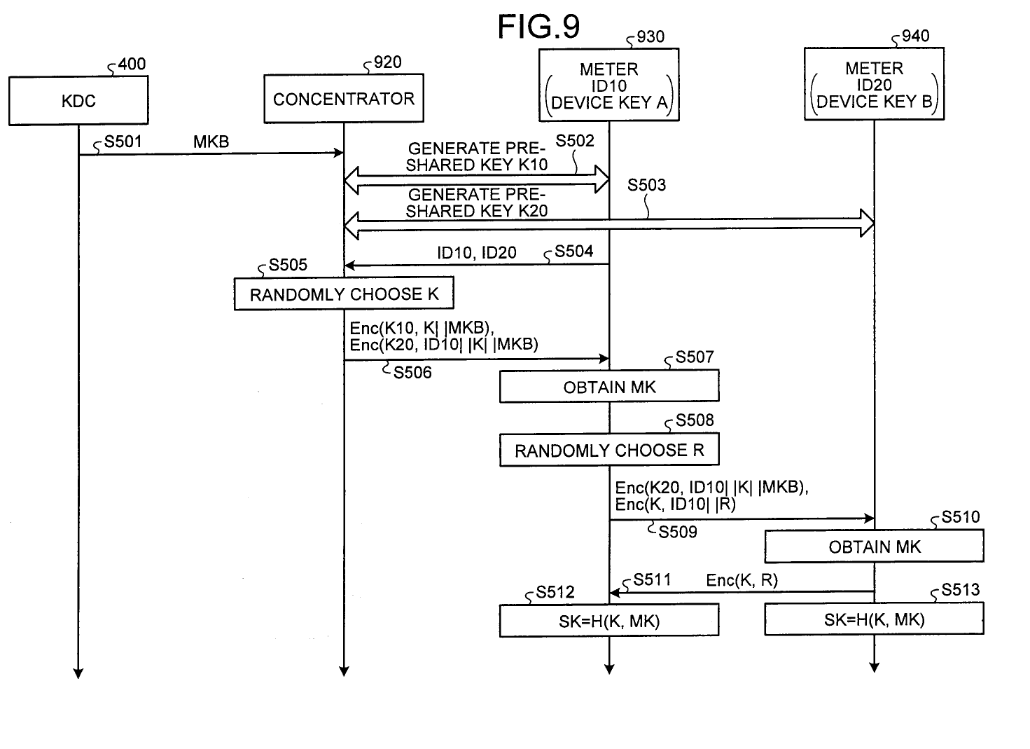

In a third embodiment, a plurality of meters employs concentrators to communicate with other meters. FIG. 9 is a sequence diagram illustrating an entire sequence of a process to share a key according to the third embodiment. In this embodiment, a concentrator 920 corresponds to the server 300 of the first embodiment. Meters 930 and 940 correspond to the devices of the first embodiment.

The KDC 400 transmits an MKB to the concentrator 920 (step S501). The concentrator 920 respectively generates pre-shared keys K10 and K20 between the meter 930 and the meter 940 (step S502, step S503).

The meter 930 transmits an identifier ID10 of the meter 930 and an identifier ID20 of the meter 940 to the concentrator 920 (step S504).

The concentrator 920 randomly chooses secret information K (step S505). The concentrator 920 generates encrypted data E1, which is generated by encrypting data (such as K∥MKB or ID20∥MKB∥K) including the K and the MKB with K10, and encrypted data E2, which is generated by encrypting data (such as ID10∥K∥MKB) including the K and the MKB with K20, and then transmits to the meter 930 (step S506).

The meter 930 decrypts the E1 among the encrypted data received to obtain the K and the MKB. The meter 930 processes the obtained MKB to generate the media key MK (step S507).

The meter 930 randomly chooses an R (step S508). The meter 930 encrypts ID10∥R with the K to generate encrypted data E3. Then the meter 930 transmits the encrypted data E2, which is generated by encrypting ID10∥K∥MKB received from the concentrator 920 with the K20, and the E3 to the meter 940 (step S509).

The meter 940 decrypts the E2 among the encrypted data received to obtain the K and the MKB. The meter 940 processes the obtained MKB to generate the media key MK (step S510). The meter 940 decrypts the E3 among the encrypted data received to obtain the R. Then the meter 940 transmits encrypted data E4, which is generated by encrypting data including the R with the K, to the meter 930 (step S511).

The meter 930 and the meter 940 each calculate shared keys SK=H(K, MK) (step S512, step S513) to use for communication.

Modification 10

In the third embodiment, the KDC 400 and the meter 930 are configured as different devices. In contrast, the system may be configured such that one device provides the function of the KDC 400 and the function of the meter 930. In this case, the meter 930 also controls the permission of communication. This configuration ensures that the permission of communication is securely controlled and limits damage to the system insofar as at least the KDC 400 stays secure, in the event that security provided by the functions of units other than the KDC 400 in the meter 940 is all broken. Accordingly, this configuration decreases the overall number of functions to secure. Consequently, this reduces achievement costs or operational costs and increases processing efficiency of the KDC 400.

Modification 11

In the third embodiment, the KDC 400 and the concentrator 920 are configured as different devices. In contrast, the system may be configured such that one device provides the function of the KDC 400 and the function of the concentrator 920. In this case, the concentrator 920 also controls the permission of communication. This configuration ensures that the permission of communication is securely controlled and limits damage to the system insofar as at least the KDC 400 stays secure, in the event that security provided by the functions of units other than the KDC 400 in the concentrator 920 is all broken. Accordingly this configuration decreases the overall number of functions to secure. Consequently, this reduces achievement costs or operational costs and increases processing efficiency of the KDC 400.

Modification 12

In the third embodiment, the encrypted data E2, which is transmitted in step S509, and the encrypted data E3, which is transmitted in step S511, are encrypted with the K. In contrast, the E2 and the E3 may be each encrypted with an SK generated in step S512 and step S513 and transmitted.

Modification 13

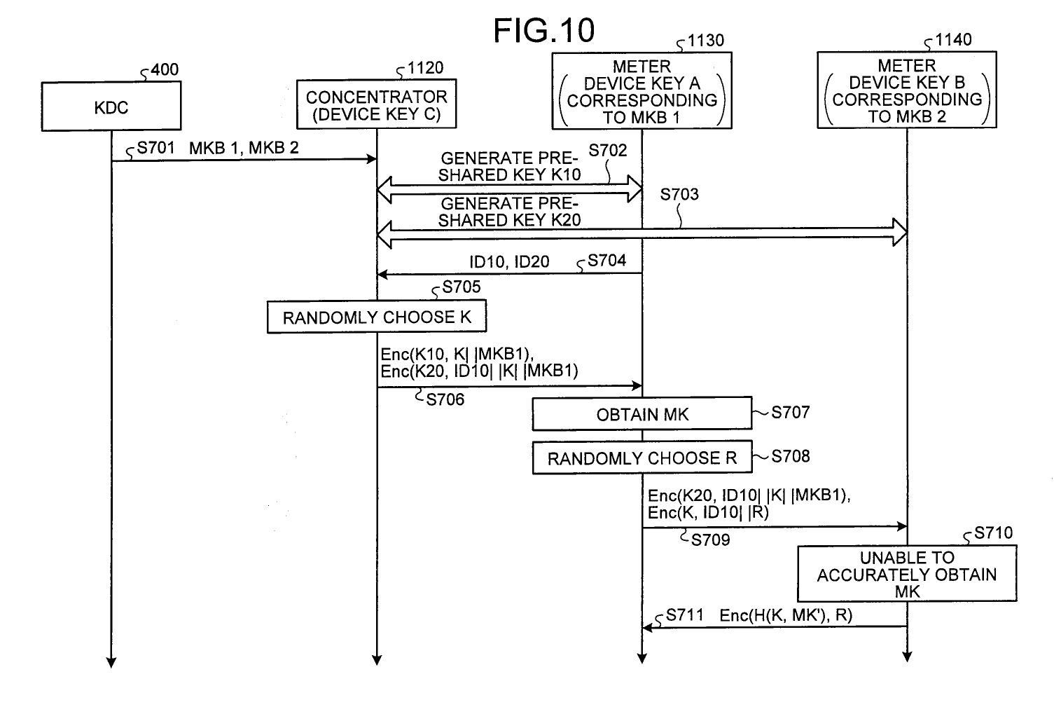

FIG. 10 is a sequence diagram illustrating an entire sequence of a process to share a key according to Modification 13. This modification employs different MKBs depending on each of the groups to which the meter belongs.

In the example in FIG. 10, a meter 1130 has a device key (a device key A) to process the MKB 1, while a meter 1140 has a device key (a device key B) to process the MKB 2.

The KDC 400 transmits the MKB 1 and the MKB 2 to an concentrator 1120 (step S701).

Step S702 through step S709 are similar to step S502 through step S509 in FIG. 9.

In this modification, since the meter 1140 does not have the device key A to process the MKB 1, the meter 1140 is unable to accurately acquire the media key MK from the MKB 1 (step S710).

The media key that the meter 1140 acquires by using the device key B to process the MKB 1 is assumed to be an MK′. It is also assumed that the meter 1140 transmits encrypted data generated by encrypting the R with the shared key (H(K, MK′)), which is generated with the media key MK′, to the meter 1130 (step S711). In this case, since the meter 1130 is unable to accurately decrypt the encrypted data encrypted with the shared key generated from the media key MK′, which is different from the media key MK, the process will be cancelled.

Thus, in this modification, the devices (the meter) can be managed in groups with the use of a plurality of the MKBs. This prevents interference between the devices that belong to different groups.

Modification 14

In Modification 14, a plurality of meters communicates with one another using a concentrator, and a KDC controls the permission of communication by the permission and the meter.

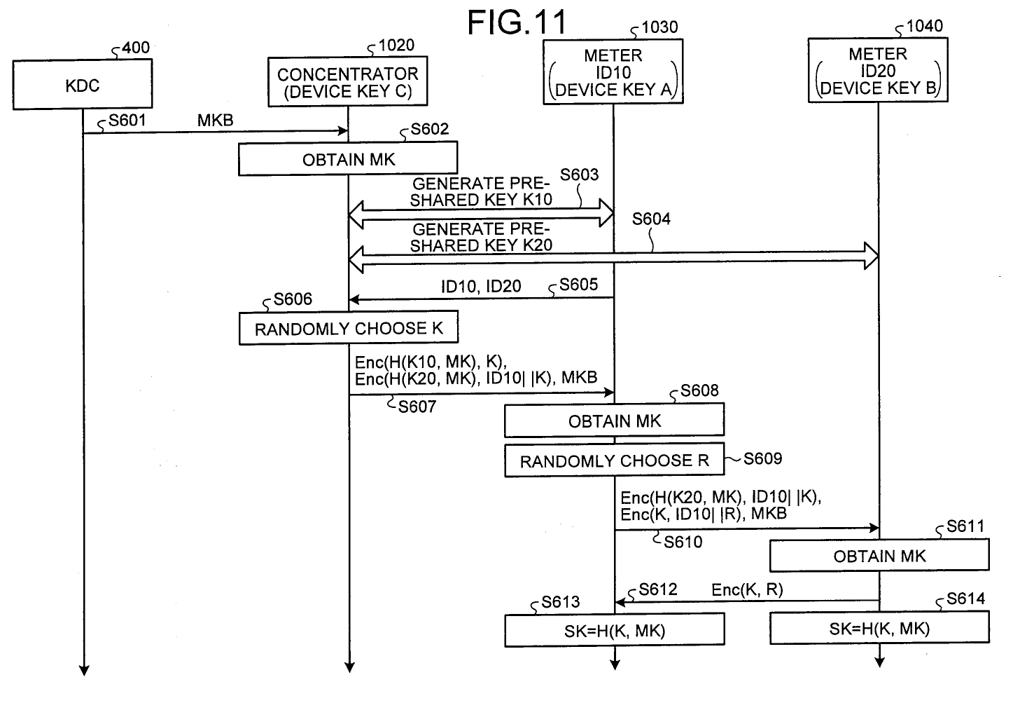

FIG. 11 is a sequence diagram illustrating an entire sequence of a process to share a key according to Modification 14. In this modification, a concentrator 1020 also has a device key (a device key C) to process an MKB. This modification employs a media key MK, which is acquired by processing the MKB for encryption, and a pre-shared key. FIG. 11 is different from FIG. 9 in the third embodiment in that the addition of step S602, and the process in step S607 and step S610. Other steps are similar to those of FIG. 9.

In step S602, the concentrator 1020 processes the MKB received from the KDC 400 to generate a media key MK (step S602). In the case where the concentrator 1020 is disabled by the MKB, the concentrator 1020 is unable to accurately process and decrypt the MKB, and is unable to accurately acquire the media key MK. In view of this, the KDC 400 updates the MKB to control the permission of communication by the concentrator 1020.

In step S607 and step S610, encrypted data is generated with a key, which is generated with the media key MK, and the MKB is transmitted without encryption. These steps are different from step S506 and step S509 in FIG. 9. In this case, the MKB may be transmitted with the signature issued to the MKB by the KDC 400, as a countermeasure against falsification of the MKB.

Modification 15

In Modification 14, the encrypted data, which is transmitted in step S610, includes the encrypted data encrypted with the K, and the encrypted data, which is transmitted in step S612, is also encrypted with the K. In contrast, respective data may be encrypted with the SK generated at step S613 and step S614 and transmitted.

As described above, a method for sharing a key is achieved with security and efficiency according to the first embodiment through the third embodiment.

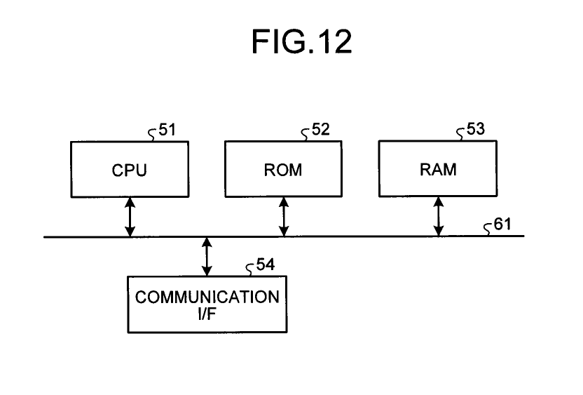

Next, the hardware configuration of each unit (the server, the device (the information-processing device), and the KDC) according to the first embodiment through the third embodiment will be described by referring to FIG. 12. FIG. 12 is a diagram illustrating a hardware configuration of the device according to the first embodiment through the third embodiment.

The device according to the first embodiment through the third embodiment has a control unit such as a central processing unit (CPU) 51, a storage unit such as a read only memory (ROM) 52 and a random access memory (RAM) 53, a communication I/F 54 to connect a network for communication, an external storage unit such as a hard disk drive (HDD) and a compact disc (CD) drive, a display unit, or a similar unit, an input unit such as a keyboard and a computer mouse, and a bus 61 to couple to respective units. The hardware is configured with an ordinary computer.

The program executed in the information-processing device according to the first embodiment through the third embodiment is provided as a computer program product, which is re/corded on a recording medium from which computers are able to read the program. The recording medium includes a compact disk read only memory (CD-ROM), a flexible disk (FD), a compact disk recordable (CD-R), and a digital versatile disk (DVD). The program is provided in an installable file format or an executable file format.

The system may be configured such that the program executed in the information-processing device according to the first embodiment through the third embodiment is stored in a computer connected to a network such as the Internet so as to be provided as a downloadable file over the network. The system may be configured such that the program executed in the information-processing device according to the first embodiment or the second embodiment is provided or distributed through a network such as the Internet.

Alternatively, the system may be configured such that the program executed in the information-processing device according to the first embodiment through the third embodiment is preliminary embedded in a ROM or a similar storage to provide.

The program executed in the information-processing device according to the first embodiment through the third embodiment is modularly configured including respective units (the MKB processor, the data processor) described above. The hardware is operated as follows. A CPU 51 (a processor) reads the program from the storage medium described above and executes the program. Then each of the units described above is loaded on a main storage unit, and each unit described above is generated on the main storage unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information-processing device to be coupled to an external device and a server, the information-processing device comprising:
a device key storage configured to store a device key;
an MKB processor configured to generate a media key, the media key being generated from the device key and a media key block; and
a shared key generator configured to generate a shared key, the shared key being generated from the media key and secret information transmitted from the server, the shared key being shared between the information-processing device and the external device.

2. The device according to claim 1 further comprising:
a receiver configured to receive the media key block transmitted from the server, wherein
the MKB processor generates the media key, the media key being generated from the device key and the media key block received from the server.

3. The device according to claim 2, wherein
the receiver receives signature information of the media key block through the server, the signature information being transmitted from a key distribution device; and
the MKB processor validates the media key block with the signature information, and generates the media key, the media key being generated from the validated media key block and the device key.

4. The device according to claim 1, wherein
the media key block is generated by a key distribution device other than the server, wherein
the information-processing device further comprises a receiver configured to receive the media key block transmitted from the key distribution device, and
the MKB processor generates the media key, the media key being generated from the device key and the media key block received from the key distribution device.

5. The device according to claim 1 further comprising:
a shared key storage configured to store a pre-shared key that is preliminarily shared between the information-processing device and the server; and
a data generator configured to decrypt encrypted information with the pre-shared key stored in the shared key storage, thereby generating the secret information, the encrypted information being generated by encrypting data including the secret information with the pre-shared key, wherein
the shared key generator generates a shared key, the shared key being generated from the generated secret information and the media key, the shared key being shared between the information-processing device and the external device.

6. The device according to claim 1 further comprising:
a shared key storage configured to store a pre-shared key that is preliminarily shared between the information-processing device and the server; and
a data generator configured to decrypt encrypted information with a decryption key, thereby generating the secret information, the encrypted information being generated by encrypting data including the secret information with an encryption key, the encryption key being calculated by the server in accordance with a predetermined method using the pre-shared key and the media key, the decryption key being calculated in accordance with a predetermined method using the pre-shared key stored in the shared key storage and the media key, wherein
the shared key generator generates a shared key, the shared key being generated from the generated secret information and the media key, the shared key being shared between the information-processing device and the external device.

7. The device according to claim 1 further comprising:
a data generator configured to generate encrypted information using the secret information;
a transmitter configured to transmit the encrypted information to the external device;
a validator configured to validate the secret information using information transmitted from the external device, the information from the external device being applied to the transmitted encrypted information, wherein
the shared key generator generates the shared key, the shared key being generated from the secret information and the media key in a case where the secret information passes a validation.

8. The device according to claim 7, wherein the data generator generates the encrypted information, using the media key and the secret information.

9. A computer program product comprising a computer-readable medium containing a program executed by a computer coupled to an external device and a server, the program causing the computer to execute:
generating a media key, the media key being generated from a device key and a media key block; and
generating a shared key, the shared key being generated from secret information and the media key, the secret information being transmitted from the server, the shared key being shared by the computer and the external device.
